(19) United States
(12) Patent Application Publication
(10) Pub. No.: US 2005/0066506 A1
(43) Pub. Date: Mar. 31, 2005

(54) Method of fitting flush glazing

(75) Inventors: Emigliano Campus, Yves Bourg (FR); Christophe Pailler, Salles Sur Mer (FR)

Correspondence Address: SUGHRUE MION, PLLC, 2100 PENNSYLVANIA AVENUE, N.W., SUITE 800, WASHINGTON, DC, 20037, US

(73) Assignee: ALSTOM

(21) Appl. No.: 10/937,775

(22) Filed: Sep. 10, 2004

(30) Foreign Application Priority Data
Sep. 11, 2003 (FR) 03 50 524

(51) Int. Cl. B23P 11/00

(52) U.S. Cl. 29/428

(57) ABSTRACT

In the disclosed method of fitting a fixed flush glazed window of a high-speed rail vehicle, a first edge of the window is first placed from the exterior of the vehicle in a groove situated on a horizontal portion of the window frame, after which the window is tilted to move the opposite second edge of the window toward the opposite horizontal portion of the window frame, and finally the opposite second edge is fixed to the opposite horizontal portion of the window frame from inside the vehicle. Thus there is no mechanical fixing to the horizontal portion of the window where the groove is located, so that it is no longer necessary to demount all of the interior fittings when changing a window, while fixing the other horizontal portion from the inside minimizes the width of the mastic. Furthermore, installation from the outside means that the window may be fitted independently of the position of the vehicle on the assembly line, since whether the interior fittings have been fitted or not is of no importance.

### BACKGROUND OF THE INVENTION

1. Field of the Invention

The present invention relates to fitting and fixing a window to a high-speed rail vehicle.

2. Description of the Prior Art

To improve their aerodynamics, rail vehicles are made with the fewest possible sharp edges, and are therefore equipped with flush glazing units that do not project from and are not set back from the exterior face of the vehicle body. A finish mastic seal is inserted into the space between the external face of the glazing unit and the window opening in the vehicle body.

At present such windows are fitted:
from inside the vehicle, which reduces the width of the bead but necessitates demounting of the interior fittings to replace a window, or
from outside the vehicle, which facilitates window replacement, because it is not necessary to demount the interior fittings, but makes it necessary to insert a wide bead of mastic, which increases the maintenance downtime, or
by installing a window pier between two window glazing units, which makes it necessary to use a greater number of parts and therefore increases fitting time on the assembly line and the number of parts in the inventory.

The fitting method of the invention reduces the width of the mastic, reduces the number of parts, and minimizes the number of fittings to be demounted during maintenance, which reduces the vehicle down time.

### SUMMARY OF THE INVENTION

In a method according to the invention of fitting a fixed flush glazed window of a high-speed rail vehicle, a first edge of the window is first placed from the exterior of the vehicle in a groove situated on a horizontal portion of the window frame, after which the window is tilted to move the opposite second edge of the window toward the opposite horizontal portion of the window frame, and finally the opposite second edge is fixed to the opposite horizontal portion of the window frame from inside the vehicle. Thus there is no mechanical fixing to the horizontal portion of the window where the groove is located, so that it is no longer necessary to demount all the interior fittings when changing a window, and fixing the other horizontal portion from the inside minimizes the width of the mastic. Also, installation from the outside means that the window may be fitted independently of the position of the vehicle on the assembly line, since whether the interior fittings have been fitted or not is of no importance.

In one variant, the groove is in the lower portion of the frame. The low position of the groove means that the fixings are situated in the upper portion of the window so that at replacement time it suffices to open the articulated voussoir to obtain access to the mechanical fixings of the window.

According to one particular feature, the window is double glazed. Double glazing provides better thermal and acoustic insulation.

According to a complementary feature, the double glazing comprises a tempered pane associated with a laminated pane. The use of tempered glass on the passenger compartment side reduces the cost of double glazing.

According to another complementary feature, the width of the laminated pane is greater than that of the tempered pane. The laminated glass therefore covers approximately half the window upright on each side (half-pier), which ensures the continuity of the glazing. The pier panes are therefore not needed, which reduces the number of parts in the inventory and optimizes the fitting time.

According to another feature, the height of the laminated pane is greater than that of the tempered pane.

According to another feature, the double glazing is assembled by adhesive bonding to a false frame consisting of two horizontal sections and two vertical sections. There is therefore no mechanical connection between the horizontal sections and the vertical sections. This design is a simple one and reduces the cost of the frame.

According to a complementary feature, the glazing unit is fixed to the vertical portions of the window from the inside, if the horizontal fixings are sufficient to support loads in service, in particular in the event of high pressure variations, as when two high-speed trains pass each other in a tunnel.

The invention will be better understood after reading the following description which is given by way of example only and with reference to the appended drawings.

### BRIEF DESCRIPTION OF THE DRAWINGS

FIG. 1 is a perspective view of a window according to the invention.

FIG. 2 is a detailed view of the bottom of a window of the invention.

FIG. 3 is a detailed view of the top of a window of the invention.

FIG. 4 is a view in section of a window pier according to the invention.

### DETAILED DESCRIPTION OF THE PREFERRED EMBODIMENT

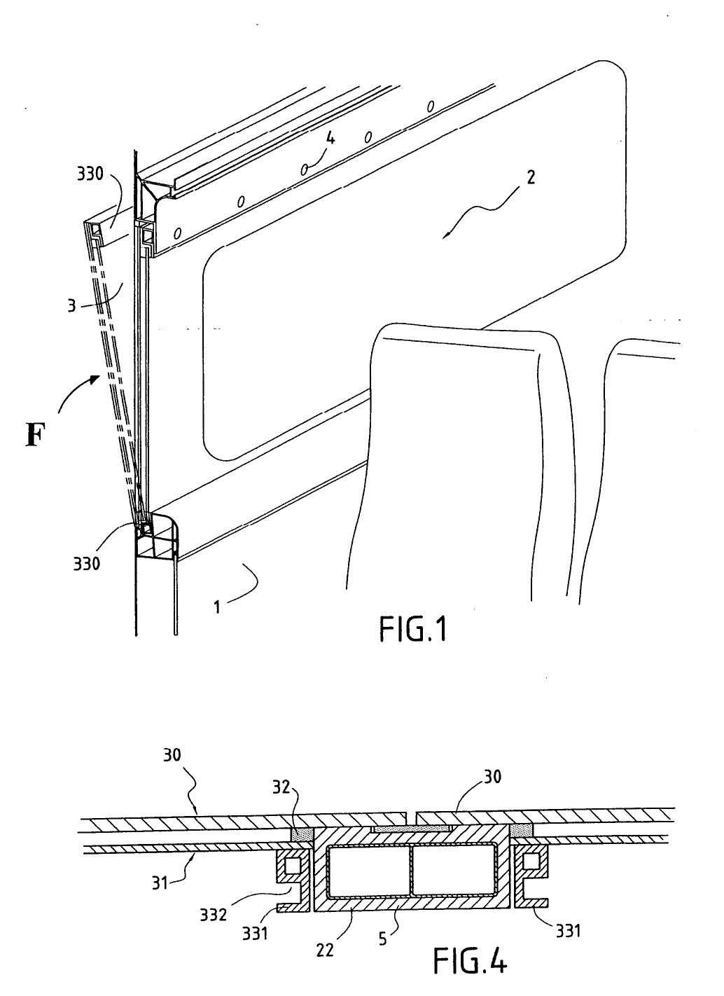

Train windows consist of a window opening 2 in the body 1 and a window comprising a glazing unit 3 and a frame 33, as may be seen in FIG. 1.

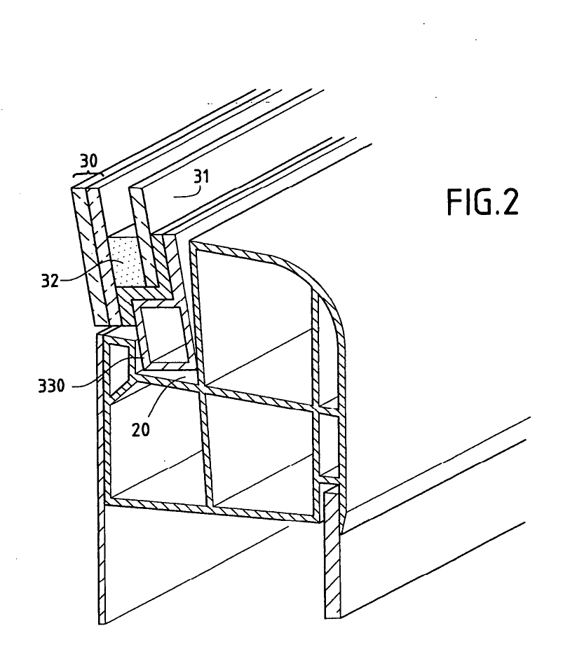

The glazing unit 3 comprises two panes, namely a pane 30 of tempered or annealed laminated glass and a pane 31 of tempered glass. The laminated pane 30 is on the outside (see FIGS. 2, 3 and 4) and is fixed to the pane 31 in the conventional way by an adhesively bonded seal 32 between the two panes 30 and 31. The panes 30 and 31 are bonded to a false frame 33 consisting of two horizontal sections 330 and two vertical sections 331. The combination of the two panes 30 and 31, the seal 32 and the false frame 33 constitutes the window 3.

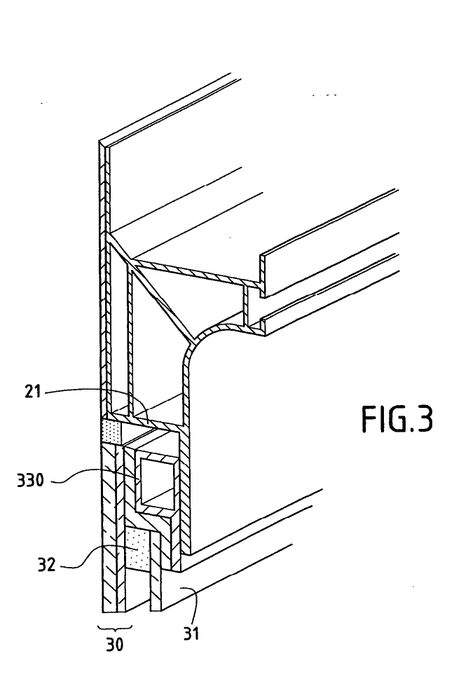

To fit the window 3, the horizontal section 330 is inserted into a groove 20 of the window opening 2, after which the window is tilted in the direction F, toward the body 1 (see FIG. 1), in order to bring the second section 330 into contact with the top 21 of the window opening 2 (see FIG. 3). The assembly is then fixed by conventional fixing means 4. Mastic is then applied between the top 21 of the window opening 2 and the top section 330 of the glazing unit to seal the connection.

The laminated pane 30 is taller and wider than the tempered pane 31, as may be seen in FIG. 4. The pane 30 covers half of the window pier 5 of the body 1, the other half being covered by the pane 30 of the next window. The exterior profile of the vehicle therefore has a continuous line of flush glazing units.

The vertical portion 330 of the false frame 33 comprises a recess 332 that constitutes a guide rail for the window blind (not shown).

1. A method of fitting a fixed flush glazed window of a high-speed rail vehicle, wherein a first edge of said window is first placed from the exterior of said vehicle in a groove situated on a horizontal portion of the window frame, after which said window is tilted to move the opposite second edge of said glazing unit toward the opposite horizontal portion of said window frame, after which said second edge is fixed to said opposite horizontal portion of said window frame from inside said vehicle.

2. The fitting method claimed in claim 1, wherein said groove is in the lower portion of said frame.

3. The fitting method claimed in claim 1, wherein said window is double glazed.

4. The fitting method claimed in claim 3, wherein said double glazing comprises a tempered pane associated with a laminated pane.

5. The fitting method claimed in claim 4, wherein the width of said laminated pane is greater than that of said tempered pane.

6. The fitting method claimed in claim 4, wherein the height of said laminated pane is greater than that of said tempered pane.

7. The fitting method claimed in claim 3, wherein said double glazing is assembled by adhesive bonding to a false frame consisting of two horizontal sections and two vertical sections.

8. The fitting method claimed in claim 1, wherein said window is fixed to vertical portions of said window from the inside.
